(19) United States
(12) Patent Application Publication
(10) Pub. No.: US 2021/0383216 A1
(43) Pub. Date: Dec. 9, 2021

(54) LEARNING DEVICE, LEARNING METHOD, AND PROGRAM

(71) Applicant: MITSUBISHI HEAVY INDUSTRIES, LTD., Tokyo (JP)

(72) Inventors: Eriko SHINKAWA, Tokyo (JP); Kenji TAKAO, Tokyo (JP); Yusuke YAMASHINA, Tokyo (JP)

(21) Appl. No.: 17/242,582

(22) Filed: Apr. 28, 2021

(30) Foreign Application Priority Data
Jun. 9, 2020 (JP) 2020-099837

(51) Int. Cl. G06N 3/08; G06N 3/04

(52) U.S. Cl. CPC G06N 3/08; G06N 3/04

(57) ABSTRACT

Provided is learning device that is a learning device of a neural network model whose bond strength between multiple neurons is represented as a weighting coefficient. The learning device is configured to optimize the weighting coefficient by using an evaluation function that includes a model reliability based on the degree of firing of each neuron of the multiple neurons and a prediction error obtained using the neural network model.

### CROSS-REFERENCE TO RELATED APPLICATIONS

This application claims the benefit of priority to Japanese Patent Application Number 2020-099837 filed on Jun. 9, 2020. The entire contents of the above-identified application are hereby incorporated by reference.

### TECHNICAL FIELD

The present disclosure relates to a learning device, a learning method, and a program for a neural network model.

### RELATED ART

In recent years, a learning device configured to predict input data using a neural network model has been developed. Since the accuracy of the learning device basically depends on the learning data of the learning phase, sufficient prediction accuracy may not be obtained when actual data of the actual operation phase is input. For example, if actual data outside of the range of learning data is entered, the prediction accuracy may be reduced even if it is quite close to the learning data.

Various attempts to solve such problems have been proposed. For example, in JP 2018-190140, a learning device is described that evaluates the degree of insufficiency of the number of learning data.

### SUMMARY

In a known learning device, only the prediction error in the learning phase is used as an evaluation function to optimize the weighting coefficient, which is the connection strength between multiple neurons. Such optimization results in an optimization result for the weighting coefficient such that only specific neurons fire without some neurons firing. In a case where a learning device that has been optimized as such, a neuron that did not fire during learning phase may fire when actual data outside of the learning data is input.

Because firing of such neurons is not sufficiently optimized, unintended behaviors may occur and prediction accuracy may be reduced. JP 2018-190140 does not describe a solution to suppress such a reduction in prediction accuracy.

In light of the foregoing, an object of the present disclosure is to provide a learning device, a learning method, and a program capable of suppressing a decrease in prediction accuracy associated with the firing of neurons that have not fired in the learning phase.

A learning device according to the present disclosure is a learning device of a neural network model in which connection strength between a plurality of neurons is represented as a weighting coefficient, the learning device being configured to optimize the weighting coefficient by using an evaluation function including a model reliability based on a degree of firing of each one of the plurality of neurons and a prediction error obtained using the neural network model.

A learning method according to the present disclosure is a learning method for a neural network model in which connection strength between a plurality of neurons is represented as a weighting coefficient, the method comprising:

evaluating the neural network model using an evaluation function including a model reliability based on a degree of firing of each one of the plurality of neurons and a prediction error obtained using the neural network model; and optimizing the weighting coefficient such that an evaluation result from the evaluating is improved.

A program according to the present disclosure is a program for causing a computer to execute learning of a neural network model in which connection strength between a plurality of neurons is represented as a weighting coefficient, the program also causing a computer to execute:

evaluating the neural network model using an evaluation function including a model reliability based on a degree of firing of each one of the plurality of neurons and a prediction error obtained using the neural network model; and optimizing the weighting coefficient such that an evaluation result from the evaluating is improved.

The present disclosure can provide a learning device, a learning method, and a program capable of suppressing a decrease in prediction accuracy associated with the firing of neurons that have not fired in the learning phase.

### BRIEF DESCRIPTION OF DRAWINGS

The disclosure will be described with reference to the accompanying drawings, wherein like numbers reference like elements.

FIG. 1 is a block diagram schematically illustrating the configuration of a predicting system provided with a learning device according to an embodiment.

FIG. 2 is a block diagram schematically illustrating the configuration of a predicting system provided with a learning device according to an embodiment.

FIG. 3 is a conceptual diagram illustrating an example of a method of calculating a neuron coverage of a learning device according to an embodiment.

FIG. 4 corresponds to FIG. 3 and is a conceptual diagram illustrating an example of the calculation result of the neuron coverage in one neuron.

FIG. 5 is a conceptual diagram illustrating an example of a method of calculating a neuron coverage of a learning device according to an embodiment.

FIG. 6 is a conceptual diagram illustrating an example of a method of calculating a neuron pattern of a learning device according to an embodiment.

FIG. 7 is a diagram illustrating an example of a ReLU function used by a learning device according to an embodiment.

FIG. 8 is a diagram illustrating an example of prediction results (a group of plots) for a learning device according to an embodiment and a learning device according to a comparative example.

FIG. 9 is a diagram illustrating an example of prediction results (time series data) for a learning device according to an embodiment and a learning device according to a comparative example.

FIG. 10 is a diagram illustrating an example of prediction results (time series data) for a learning device according to an embodiment and a learning device according to a comparative example.

FIG. 11 is a flowchart for describing an example of the processing executed by a learning device according to an embodiment.

### DESCRIPTION OF EMBODIMENTS

An embodiment will be described hereinafter with reference to the appended drawings. However, dimensions, materials, shapes, relative positions and the like of components described in the embodiments or illustrated in the drawings shall be interpreted as illustrative only and not intended to limit the scope of the disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance within a range in which it is possible to achieve the same function.

For instance, an expression of an equal state such as “same”, “equal”, “uniform” and the like shall not be construed as indicating only the state in which the feature is strictly equal, but also includes a state in which there is a tolerance or a difference within a range where it is possible to achieve the same function.

Further, for instance, an expression of a shape such as a rectangular shape, a cylindrical shape or the like shall not be construed as only the geometrically strict shape, but also includes a shape with unevenness, chamfered corners or the like within the range in which the same effect can be achieved.

On the other hand, an expression such as “comprise”, “include”, “have”, “contain” and “constitute” of one constituent element are not intended to be exclusive of other constituent elements.

### Overall Configuration of Predicting System

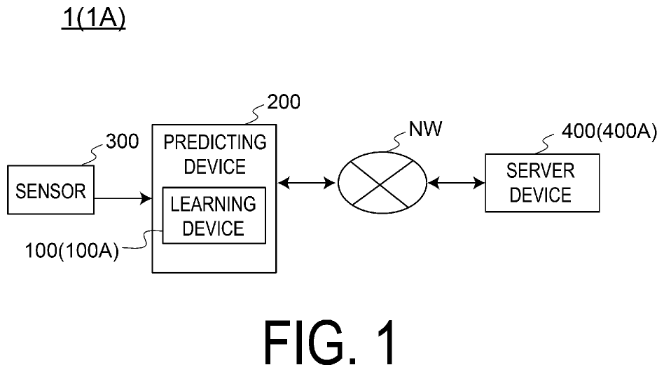

The configuration of a predicting system 1 provided with a learning device 100 according to an embodiment is described below. FIG. 1 is a block diagram schematically illustrating the configuration of the predicting system 1 (1A) provided with the learning device 100 (100A) according to an embodiment.

As illustrated in FIG. 1, the predicting system 1 (1A) includes one or more sensors 300 provided in a facility such as a plant, a predicting device 200 configured to predict target variables in a case where measurement values are obtained from the one or more sensors 300 and set as explanatory variables, and a server device 400 (400A) configured to communicate with the predicting device 200 via a network NW. The predicting device 200 includes the learning device 100 (100A) for optimizing the prediction model by machine learning and predicts via the stored prediction model.

Note that the network NW is, for example, a World Area Network (WAN) or a Local Area Network (LAN). A gateway device, such as a modem or router, is omitted from the diagram.

In the predicting system 1 (1A), the predicting device 200 is disposed at a location (on-site) of a facility such as a plant, and the server device 400 (400A) is disposed at a monitoring site (remote location). The prediction result of the predicting device 200 is transmitted to the server device 400 (400A). The operator may confirm the prediction result of the predicting device 200 via the server device 400 (400A) and transmit various instruction signals to the predicting device 200 via the server device 400 (400A) and the network NW. According to such a predicting system 1 (1A), prediction and optimization can be performed on-site.

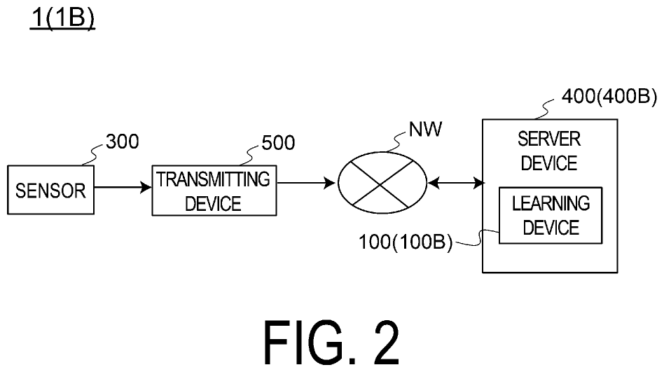

FIG. 2 is a block diagram schematically illustrating the configuration of the predicting system 1 (1B) provided with the learning device 100 (100B) according to an embodiment. As illustrated in FIG. 2, the predicting system 1 (1B) includes the one or more sensors 300 provided in a facility such as a plant, a transmitting device 500 configured to acquire measurement values from the one or more sensors 300 and transmit these to the server device 400 (400B) via the network NW, and the server device 400 (400B) configured to communicate with the transmitting device 500 via the network NW. The server device 400 (400B) includes the learning device 100 (100A) for optimizing the prediction model by machine learning and predicts via the stored prediction model.

In the predicting system 1 (1B), the transmitting device 500 is disposed at a location (on-site) of a facility such as a plant, and the server device 400 (400B) is disposed at a monitoring site (remote location). The server device 400 (400B) is configured to predict a target variable in a case where the measurement value received from the transmitting device 500 is set as an explanatory variable. The operator may confirm the prediction result output from server device 400 (400B). According to such a predicting system 1 (1B), prediction and optimization can be performed at a remote location.

Note that the configuration of the predicting system 1 is not limited to an edge type as illustrated in FIG. 1 or a cloud type as illustrated in FIG. 2. For example, the predicting system 1 may have a local configuration that does not use the network NW. In this case, predictions and optimization by learning can be performed on-site, and the operator can confirm the prediction result on-site. Furthermore, the predicting system 1 can be configured to perform predictions on-site and execute processing necessary for optimization at a remote location. For example, such a configuration can be realized by disposing the predicting device 200 in which the prediction model has been stored on-site and disposing the learning device 100 at a remote location, and communicatively connecting the two.

### Learning Device Configuration

The learning device 100 may be constituted by multiple devices rather than one device. That is, the learning device 100 may be implemented by the cooperation of multiple devices by distributing the functions between multiple devices. The learning device 100 may be a device independent from the predicting device 200 and the server device 400.

The learning device 100 is provided with a processor, such as a central processing unit (CPU) and a graphics processing unit (GPU) and a memory, such as a random access memory (RAM) and a read only memory (ROM), for example. The memory of the learning device 100 stores programs for executing various control processes and various data.

The memory of the learning device 100 stores, as a prediction model, a neural network model whose connection strength between multiple neurons is expressed as a weighting coefficient. In addition, the memory of the learning device 100 stores programs for performing machine learning and information such as prediction results, various types of calculation expressions, evaluation results, learning data, and the like. The learning device 100 implements various functions described below by a processor executing a program stored in the memory.

The learning device 100 is configured to optimize weighting coefficients between neurons using an evaluation function that includes a model reliability based on the degree of firing of each neuron of the neural network model and a prediction error obtained using the neural network model. The neural network model of the learning device 100 may be a convolutional neural network (CNN) or a recurrent neural network (RNN). Note that details of the evaluation function will be described below.

The model reliability may include neuron coverage indicating a firing tendency of the entire plurality of neurons. The model reliability may be an index based on one or more of a degree of firing in each of the plurality of neurons included in the neural network, a degree of firing of the neurons in a layer of the neural network model including a plurality of layers, and a degree of diversity of firing patterns of the plurality of neurons.

The degree of firing of neurons means coverage such that an output value φ of neurons, rather than being close to one, is evenly output from multiple neurons. Note that although some papers define firing as the magnitude of the output value of a neuron exceeding a threshold value, the present disclosure defines firing as output being evenly output.

As described above, in a case where a neuron that has not fired during learning fires during actual operation, the prediction accuracy tends to decline. In other words, neurons that do not fire once during learning are difficult to adequately optimize. Thus, there are preferably less neurons that do not fire during learning, and improvement in the robustness of the learning device 100 is achieved with unbiased firing of the neurons, or in other words, improved neuron coverage or diversification of neuron patterns.

### Method of Calculating Neuron Coverage and Neuron Patterns

The method of calculating the neuron coverage as model reliability may include calculating for each neuron and calculating for each layer of the multiple layers of the neural network.

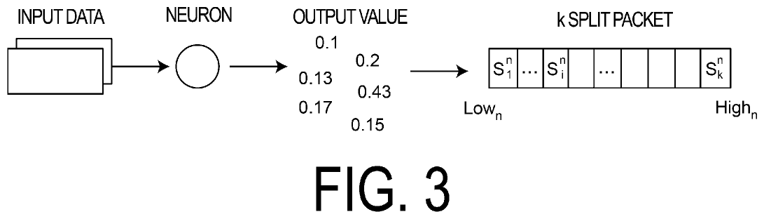

First, as an example of calculating for each neuron, k-Multisection Neuron Coverage (KMN) is described. FIG. 3 is a conceptual diagram illustrating an example of a method of calculating a neuron coverage of the learning device 100 according to an embodiment.

As illustrated in FIG. 3, first, the learning device 100 inputs multiple input data x in one neuron n and obtains a plurality of output values φ (x, n). x (because x is a vector, is it written in bold, the same applies below) is represented by a collection of data extracted from a data set T for calculating the coverage. The data set T may be all or a portion of the learning data or may be actual data that is not learning data.

A maximum value Highₙ and a minimum value Lowₙ of the obtained output value φ (x, n) are obtained by the learning device 100. The numerical range from the minimum value Lowₙ to the maximum value Highₙ (Lowₙ≤φ (x, n)≤Highₙ) is divided into k number of regions (split packets S) by the learning device 100.

The number of divisions k may be set to any value by the user. The subscripts (1 . . . i . . . k) below the split packets S indicate the ordinal number of the split packets S. The subscript n above the split packets S indicate the nth neuron of the plurality of neurons. Next, for all of the plurality of input data x, how much the output value φ (x, n) of the neuron n covers the k number of split packets is determined by the learning device 100.

For example, a neuron coverage Cov in one neuron can be calculated using the following Formula (1). In Formula (1), the numerator indicates the number of split packets S to which a plurality of output values φ (x, n) belong, and the denominator is the number of divisions k.

$$Cov = \frac{\vert \{ {S}_{i}^{n} \vert ∃ x ∈ T : ϕ ( x , n ) ∈ {S}_{i}^{n} \} \vert}{k} . \qquad ( 1 )$$

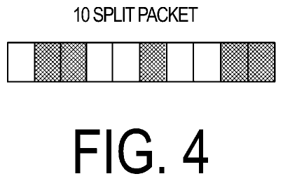

FIG. 4 corresponds to FIG. 3 and is a conceptual diagram illustrating an example of the calculation result of the neuron coverage in one neuron n. For example, let's assume that the number of divisions k=10, the maximum value Highₙ=1, and the minimum value Lowₙ=0. In this case, it is assumed that the output values φ (x, n) in a case where a plurality of input data x is input to the neuron n are the following seven values: 0.11, 0.15, 0.23, 0.51, 0.88, 0.92, and 0.96.

Then, as indicated by the hatching in FIG. 4, the second, third, sixth, ninth, and tenth split packets S of the ten split packets S are covered. In this case, the neuron coverage Cov is 0.5 (half of one neuron n fires). Higher values are determined to indicate higher model reliability. Note that the neuron coverage basically increases when the amount of learning data is large. However, even if the learning data is increased due to the bias in the learning data, the neuron coverage is often saturated without becoming 1.

Such calculations may be extended by the learning device 100 to determine the coverage in a case where the data set T is input to all neurons N, in other words, a neuron coverage KMNCov for the entire neural network. For example, the neuron coverage KMNCov for the entire neural network can be calculated using the following Formula (2). In Formula (2), the numerator is a value obtained by summing the number of split packets S to which the plurality of output values φ (x, n) of the neurons n belong to by all of the neurons N, and the denominator is the number of divisions k and the number of neurons n included in all of the neurons N.

$$KMNCov ( T , k ) = \frac{{\sum }_{n ∈ N} \vert \{ {S}_{i}^{n} \vert ∃ x ∈ T : ϕ ( x , n ) ∈ {S}_{i}^{n} \} \vert}{k \times \vert N \vert} \qquad ( 2 )$$

Note that the approach described above focuses on how much the output values φ (x, n) cover the k number of split packets S. However, the difference between the maximum value Highₙ and the minimum value Lowₙ is too small and may deviate upon entry of the untrained data set T. An evaluation method may be applied that determines the model reliability to be low in such cases. In this manner, there is flexibility in what evaluation method to use, and this can be changed as appropriate.

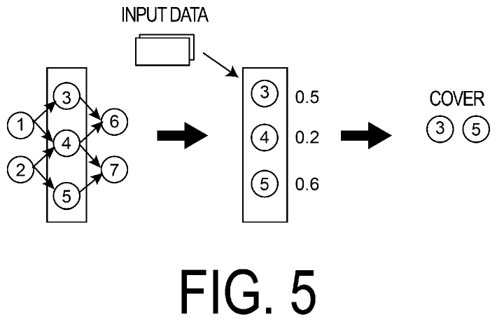

Next, as an example of calculating for each layer of a multiple layer neural network, a Top-k Neuron Coverage (TKN coverage) will be described. FIG. 5 is a conceptual diagram illustrating an example of a method of calculating a neuron coverage of the learning device 100 according to an embodiment.

First, in a case where multiple input data x is input to a layer, the learning device 100 extracts the k number of neurons with a higher degree of firing from all of the neurons N. In all cases, if the neurons in the layer have been extracted, it is determined that the model reliability is high. The number k of extracted neurons may be set to any value by the user.

In the example illustrated in FIG. 5, the neural network includes three layers of seven neurons numbered 1 to 7. Here, a plurality of input data x is input to the three neurons, third to fifth, in the two layers, and output values φ (x, n) for each neuron are obtained. The output value φ (x, n) for the third is 0.5, for the fourth is 0.2, and for the fifth is 0.6. In a case where k=2, the third and fifth neurons are selected because the top two are extracted. What percentage to select is determined in a case where these selected neurons are input in the data set T (a collection of input data including multiple input data x). Note that the data set T may be learning data.

For example, a neuron coverage TKNCov in one layer can be calculated using the following Formula (3). In Formula (3), 1 is the number of layers of the neural network, and i represents the ith layer of the layers.

$$TKNCov ( T , k ) = \frac{\vert {⋃}_{x ∈ T} ( {⋃}_{1 \leq i \leq l} {top}_{k} ( x , i ) ) \vert}{\vert N \vert} . \qquad ( 3 )$$

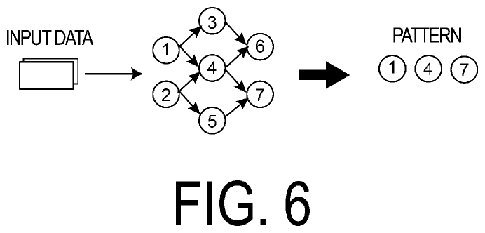

Next, a method of calculating a neuron pattern as model reliability will be described. Specifically, a case in which a Top-k Neuron Pattern (neuron pattern TKNPat) in a neural networks of multiple layers is calculated will be described. FIG. 6 is a conceptual diagram illustrating an example of a method of calculating a neuron pattern of the learning device 100 according to an embodiment.

As illustrated in FIG. 6, first, the learning device 100 inputs multiple input data x in all of the neurons n and obtains a plurality of output values φ (x, n). x represents a collection of data extracted from the data set T to calculate the coverage. Note that the data set T used in the coverage calculation may be learning data.

Here, the k number of upper neurons of the degree of firing are extracted from each layer by the learning device 100. The number k of extracted neurons may be set to any value by the user. By extracting these neurons, a neuron pattern is obtained.

For example, in the example illustrated in FIG. 6, k=1, and based on the magnitude of the output value φ (x, n), the first neuron is extracted from the first layer is extracted, the fourth neuron is extracted from the second layer, and the seventh neuron is extracted from the third layer. In this case, the neuron pattern is 1, 4, 7. The neuron pattern is determined for all input data x by the learning device 100. As a result, it is determined that the model reliability is high if there is a diversity in the resulting neuron patterns.

For example, the neuron pattern TKNPat can be calculated using the following formula (4). In Formula (4), 1 is the number of layers of the neural network.

TKNPat(T,k)=|{(topₖ(x,1), . . . ,topₖ(x,l))|x∈T}| (4)

### Example of Evaluation Function

An example of the evaluation function used by the learning device 100 will be described below. The learning device 100 is configured to perform optimization so that the evaluation function is minimal.

The evaluation function used by the learning device 100 according to an embodiment is a function (loss function) including a linear combination sum of the member (acc_loss function) indicating the prediction error and the member (cov_loss) relating to neuron coverage indicating model reliability. For example, as in Formula (5) below, the learning device 100 may be configured to adjust the weighting of each member by a weighting coefficient μ to determine an evaluation function (loss function).

loss=μ×acc_loss+(1−μ)cov_loss (5)

The acc_loss function indicating the prediction error may be the difference between the measured value (the correct value) and the prediction value. The member relating to neuron coverage may be a value obtained via executing threshold processing with an activation function on information indicating the output value of the neuron or the cell-state of the neuron.

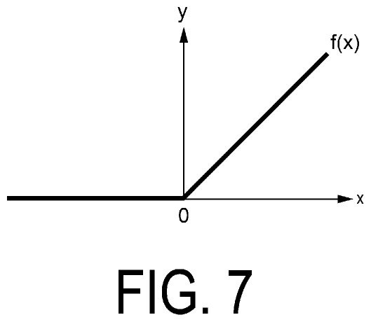

FIG. 7 is a diagram illustrating an example of a ReLU function used by the learning device 100 according to an embodiment. In some embodiments, for example, the ReLU function illustrated in FIG. 7 may be used as an activation function. When the ReLU function is expressed as a function of x (not the input data x described above), f (x)=max (0, x). That is, if x is a positive value, f(x)=x, and if x is a negative value, f(x)=0.

In some embodiments, the member cov_loss for neuron coverage may be calculated, for example, using Formula (6) below. In this formula, h(n) is the output value φ (x, n) of the neuron n, and threshold is the threshold value set for issue. ReLU indicates the ReLU function, and N indicates the number of all of the neurons.

$$cov\_loss = \frac{{\sum }_{n ∈ N} Re LU ( - ( h ( n ) - threshold ) )}{\vert N \vert} \qquad ( 6 )$$

Note that h(n) may be an index that is not the output value φ (x, n) of the neuron n. For example, in a Long Short Term Memory (LSTM), one example of a deep learning method, it is also possible to use values indicating the cell-state of the neurons. Also, in other embodiments, an activation function that is not a ReLU function (e.g., a sigmoid function) may be used. The member (cov_loss) for neuron coverage in Formula (5) may be substituted with a value (a value obtained by inverting the positive and negative) obtained by executing processing on a value obtained in Formulas (1) to (4), instead of the value obtained in Formula (6). Alternatively, instead of Formula (6), it may be calculated as cov_loss=1−Cov (the value of Cov obtained in Formula (1)) and substituted into Formula (5).

### Description of Effects

The effects of using the learning device 100 according to an embodiment will be described below while comparing the effects of a learning device (not illustrated) according to a comparative example. In the learning device 100 according to an embodiment, as described above, the learning device is optimized using an evaluation function including the member relating to neuron coverage, and the learning device according to the comparative example differs in that it is optimized using an evaluation function that does not include the member relating to neuron coverage.

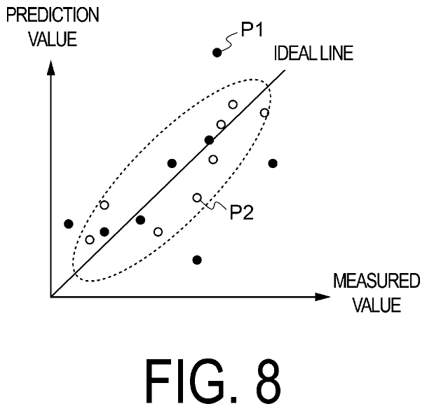

FIG. 8 is a diagram illustrating an example of prediction results (a group of plots) for the learning device 100 according to an embodiment and the learning device according to the comparative example. In the illustrated graph, the vertical axis indicates the prediction value, and the horizontal axis indicates the measured value (the correct value). The smaller the difference between the prediction value and the measured value, the smaller the prediction error. Thus, it is desirable that the group of plots be distributed in the region close to the ideal line.

The group of plots indicated by black plots P1 is the prediction result of learning device 100. The group of plots indicated by white plot P2 is the prediction result of the learning device according to the comparative example. In the comparative example, the individual plots P2 are offset from the ideal line due to optimization to reduce the overall average error of prediction values. On the other hand, in an embodiment, the individual plots P1 are near the ideal line. The prediction results of the learning device 100 contain a group of plots in a region close to the ideal line indicated by the dashed line. On the other hand, in the comparative example, the group of plots does not fit in thi s region. Therefore, it can be seen that the prediction accuracy of the learning device 100 is higher than that of the learning device of the comparative example.

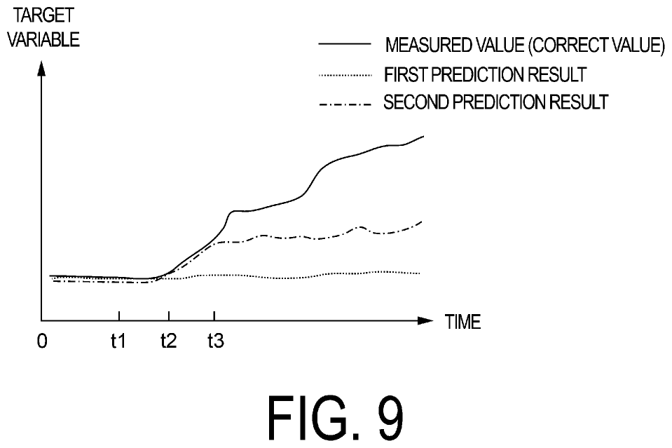

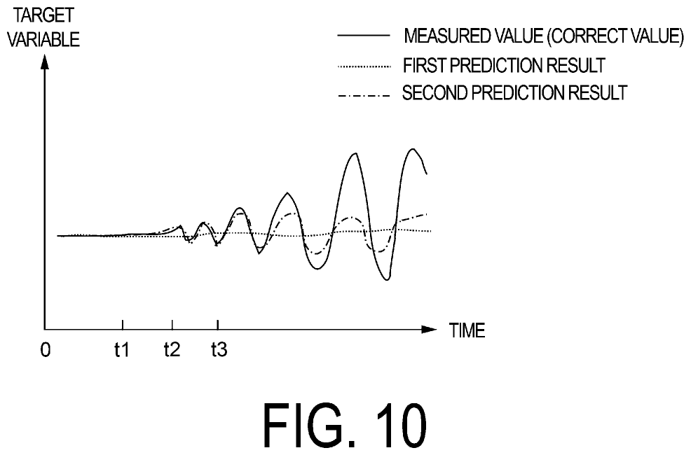

FIGS. 9 and 10 are diagrams illustrating examples of prediction results (time series data) for the learning device 100 according to an embodiment and the learning device according to the comparative example. In the graphs illustrated in FIGS. 9 and 10, the vertical axis indicates the size of the target variable and the horizontal axis indicates the time. The solid line indicates a time shift of the measured value (correct value), the dotted line indicates a first prediction result, which is a prediction result of the learning device according to the comparative example, and the dot-dash line indicates a second prediction result, which is a prediction result of the learning device 100 according to an embodiment.

At a time from time 0 to time t1, the input data, which is an explanatory variable, is training data (learning data). That is, this time is the learning time. At time t1 to time t2, the input data, which is an explanatory variable, is trained learning data. At a time from time t2 to time t3, the input data, which is an explanatory variable, is actual data (untrained data) similar to the learning data. After time t3, the input data, which is an explanatory variable, is actual data (untrained data) that is not similar to the learning data.

Looking at these graphs, at times from time 0 to time t2, neither the first prediction result nor the second prediction result remains at a value near the measured value. However, at a time from time t2 to time t3, the first prediction result has a large separation or prediction error from the measured value. On the other hand, the second prediction result remains small in terms of separation with the measured value, i.e., the prediction error is small. That is, in the comparative example, even the actual data similar to the learning data has low accuracy, while in an embodiment the actual data is highly accurate. In this way, the learning device 100 can increase the predictable range and improve robustness.

### Process Flow

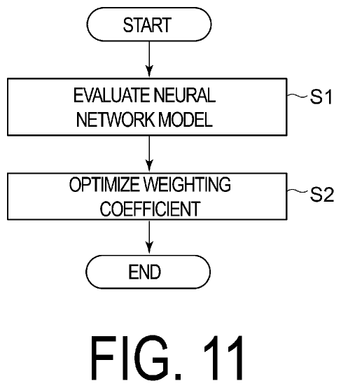

Hereinafter, the flow of the optimization processing of the prediction model by the learning device 100 will be described. FIG. 11 is a flowchart for describing an example of the processing executed by the learning device 100 according to an embodiment.

The learning device 100 evaluates the neural network model using an evaluation function that includes a model reliability based on the degree of firing of each neuron and a prediction error obtained using the neural network model (step S1). The learning device 100 optimizes a weighting coefficient representing the connection strength between the plurality of neurons so that the evaluation result of the neural network model in step S1 is improved (step S2).

The present disclosure is not limited to the embodiments described above and also includes a modification of the above-described embodiments as well as appropriate combinations of embodiments.

### SUMMARY

The details described in each embodiment can be understood as follows, for example.

(1) A learning device (100) according to the present disclosure is a learning device of a neural network model in which connection strength between a plurality of neurons is represented as a weighting coefficient, the learning device being configured to optimize the weighting coefficient by using an evaluation function including a model reliability based on a degree of firing of each one of the plurality of neurons and a prediction error obtained using the neural network model.

According to the configuration described above, not only the prediction error, but also the model reliability based on the degree of firing of each neuron is also used for optimization of the weighting coefficient. Thus, it is possible to suppress a decrease in prediction accuracy associated with firing of neurons that have not fired in the learning phase.

(2) In some embodiments, in the configuration of (1) described above, the model reliability includes a neuron coverage indicating an overall firing tendency of the plurality of neurons.

According to the configuration described above, optimization can be performed by reducing the proportion of neurons in the plurality of neurons have not fired once in the learning phase.

(3) In some embodiments, in the configuration of (1) or (2) described above,

the model reliability is an index based on one or more of the degree of firing of each one of the plurality of neurons, the degree of firing of the neurons in a layer of the neural network model including a plurality of layers, or a degree of diversity of firing patterns of the plurality of neurons.

According to the configuration described above, it is possible to realize optimization suitable for the structure of the neural network model.

(4) In some embodiments, in the configuration of any one of (1) to (3) described above, the evaluation function is a function including a linear combination sum of a member indicating the prediction error and a member relating to a neuron coverage indicating the model reliability.

According to the above-described configuration, by adjusting the bonding coefficient of the linear combination sum taking into account the prediction error and the priority order of the neuron coverage, it is possible to achieve optimization suited for the application.

(5) In some embodiments, in the configuration of (4) described above,

the member relating to the neuron coverage is a value obtained via threshold processing with an activation function on information indicating an output value of the neuron or a cell-state of the neuron.

According to the configuration described above, by adjusting the threshold value, the degree of influence of the member relating to neuron coverage exerted on the evaluation function can be adjusted.

(6) A learning method according to the present disclosure is a learning method for a neural network model in which connection strength between a plurality of neurons is represented as a weighting coefficient, the method comprising:

evaluating the neural network model using an evaluation function including a model reliability based on a degree of firing of each one of the plurality of neurons and a prediction error obtained using the neural network model; and optimizing the weighting coefficient such that an evaluation result from the evaluating is improved.

According to the method described above, not only the prediction error, but also the model reliability based on the degree of firing of each neuron is also used for optimization of the weighting coefficient. Thus, it is possible to suppress a decrease in prediction accuracy associated with firing of neurons that have not fired in the learning phase.

(7) A program according to the present disclosure is a program for causing a computer to execute learning of a neural network model in which connection strength between a plurality of neurons is represented as a weighting coefficient, the program also causing a computer to execute:

evaluating the neural network model using an evaluation function including a model reliability based on a degree of firing of each one of the plurality of neurons and a prediction error obtained using the neural network model; and

optimizing the weighting coefficient such that an evaluation result from the evaluating is improved.

According to the program described above, not only the prediction error, but also the model reliability based on the degree of firing of each neuron is also used for optimization of the weighting coefficient. Thus, it is possible to suppress a decrease in prediction accuracy associated with firing of neurons that have not fired in the learning phase.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A learning device of a neural network model in which connection strength between a plurality of neurons is represented as a weighting coefficient, the learning device being configured to optimize the weighting coefficient by using an evaluation function including a model reliability based on a degree of firing of each one of the plurality of neurons and a prediction error obtained using the neural network model.

2. The learning device according to claim 1, wherein
the model reliability includes a neuron coverage indicating an overall firing tendency of the plurality of neurons.

3. The learning device according to claim 1, wherein
the model reliability is an index based on one or more of the degree of firing of each one of the plurality of neurons, the degree of firing of the neurons in a layer of the neural network model including a plurality of layers, or a degree of diversity of firing patterns of the plurality of neurons.

4. The learning device according to claim 1, wherein
the evaluation function is a function including a linear combination sum of a member indicating the prediction error and a member relating to a neuron coverage indicating the model reliability.

5. The learning device according to claim 4, wherein
the member relating to the neuron coverage is a value obtained via threshold processing with an activation function on information indicating an output value of the neuron or a cell-state of the neuron.

6. A learning method for a neural network model in which connection strength between a plurality of neurons is represented as a weighting coefficient, the method comprising:
evaluating the neural network model using an evaluation function including a model reliability based on a degree of firing of each one of the plurality of neurons and a prediction error obtained using the neural network model; and
optimizing the weighting coefficient such that an evaluation result from the evaluating is improved.

7. A non-transitory computer readable recording medium storing a program for causing a computer to execute learning of a neural network model in which connection strength between a plurality of neurons is represented as a weighting coefficient, the program also causing a computer to execute:
evaluating the neural network model using an evaluation function including a model reliability based on a degree of firing of each one of the plurality of neurons and a prediction error obtained using the neural network model; and
optimizing the weighting coefficient such that an evaluation result from the evaluating is improved.
